(19) United States
(12) Patent Application Publication
(10) Pub. No.: US 2026/0280998 A1
(43) Pub. Date: Sep. 17, 2026

(54) PERFORMING A CLOSED-LOOP PREDICTION BASED ON BEHAVIOR OF A NETWORK IN RESPONSE TO A CONTROL POLICY

(71) Applicant: TELEFONAKTIEBOLAGET LM ERICSSON (PUBL), Stockholm (SE)

(72) Inventors: Mathieu LECONTE, Verrières-le-Buisson (FR); Sabrine AROUA, Antony (FR); Konstantinos VANDIKAS, Solna (SE); Antonio INIESTA GONZALEZ, Madrid (ES); Jaeseong JEONG, Solna (SE); Maxime BOUTON, Stockholm (SE)

(73) Assignee: TELEFONAKTIEBOLAGET LM ERICSSON (PUBL), Stockholm (SE)

(21) Appl. No.: 19/167,783

(22) PCT Filed: May 15, 2023
(86) PCT No.: PCT/EP2023/063011

§ 371 Date: Sep. 22, 2025

(30) Foreign Application Priority Data
Mar. 22, 2023 (GR) 20230100232

(51) Int. Cl. H04L 41/147; H04L 41/0894; H04L 41/16

(52) U.S. Cl. CPC H04L 41/147; H04L 41/0894; H04L 41/16

(57) ABSTRACT

A first network node, in a communications network that includes a second network node, can receive an identifier of a control policy from the second network node. The first network node can determine a prediction model to use based on the identifier of the control policy. The first network node can determine a predicted future state of the communications network using the prediction model. The first network node can transmit a message to the second network node. The message can include an indication of the predicted future state of the communications network.

### TECHNICAL FIELD

The present disclosure is related to wireless communication systems and more particularly to performing a closed-loop prediction based on behavior of a network in response to a control policy.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”), multiple communication devices 110 (also referred to as user equipment (“UE”)).

A network node can be configured to provide a network function (“NF”) and/or a network data analytics function (“NWDAF”). NFs can subscribe to a NWDAF to receive analytics reports, or NFs can transmit individual requests to the NWDAF for an analytic report. The analytics reports can include estimates of the current state of the network (e.g., estimates of some metrics, such as key performance indicators (“KPIs”), that are of interest to the NF) and predictions of the future state. In order to make the predictions, the NWDAF may require that the NF inform the NWDAF the control actions that the NF plans to perform. However, the NF may not always inform the NWDAF of the control actions that the NF plans to perform.

### SUMMARY

Certain aspects of the disclosure and their embodiments may provide solutions to these or other challenges. Various embodiments herein enable closed-loop predictions to be made by a NWDAF without knowledge/use of specific actions performed by a NF. In some embodiments, instead of trying to learn the impact on the network state of the (invisible) control actions exerted by an NF, the NWDAF tries to learn the impact of the control policy of the NF on the evolution of the network state, which can be referred to as the behavior of the control policy.

According to some embodiments, a method performed by a first network node in a communications network that includes a second network node is provided. The method includes receiving an identifier of a control policy from the second network node. The method further includes determining a prediction model to use based on the identifier of the control policy. The method further includes determining a predicted future state of the communications network using the prediction model. The method further includes transmitting a message to the second network node. The message includes an indication of the predicted future state of the communications network.

According to other embodiments, a method performed by a first network node in a communications network that includes a second network node is provided. The method includes monitoring behavior of the communications network during a period of time in which a control policy is implemented by the second network node. The method further includes generating a prediction model based on the behavior of the communications network during the period of time. The method further includes determining an identifier of the control policy. The method further includes associating the prediction model with the identifier of the control policy.

According to other embodiments, a method performed by a second network node in a communications network that includes a first network node is provided. The method includes transmitting an indication of an identifier of a first control policy of a plurality of control policies to a first network node. The method further includes, responsive to transmitting the identifier of the first control policy, receiving a message from the first network node. The message includes an indication of a predicted future state of the communications network. The method further includes determining a second control policy of the plurality of control policies based on the predicted future state of the communications network.

According to other embodiments, a method performed by a second network node in a communications network that includes a first network node is provided. The method includes applying a control policy to the communications network. The method further includes determining an identifier of the control policy. The method further includes transmitting an indication of the identifier of the control policy to the first network node without an indication of control actions associated with the control policy.

According to other embodiments, a method performed by a second network node in a communications network that includes a first network node is provided. The method includes applying a control policy to the communications network. The method further including receiving an indication of an identifier of the control policy from the first network node.

According to other embodiments, a NWDAF, a NF, a network node, a system, a host, a computer program, a computer program product, or a non-transitory computer readable medium is provided and configured to perform one of the above methods.

Certain embodiments may provide one or more of the following technical advantages. In some embodiments, the NWDAF are enabled to improve the accuracy of the analytics in the case of private actions, in that the NWDAF may provide better and more accurate predictions by implicitly taking into account the actions which the NFs may take.

In additional or alternative embodiments, the NFs are enabled to better optimize their control policy, i.e., choose control actions which are more efficient to drive the network into a desirable state (or away from undesirable states), by enabling useful closed-loop predictions even when the NWDAF does not know the control actions taken by an NF. The closed-loop predictions are important for reaching an efficient control by the NFS, because they provide accurate and contextual predictions of the effect of the control action which the NFs might take.

In additional or alternative embodiments, the NFs are enabled to keep their actions private, which may be an important feature to enable multi-vendor operation. The NF can then fully trust the NWDAF to not make an undesirable use of its knowledge of the NF's control policy (because it does not know the actual control policy but only its impact on the network state).

In additional or alternative embodiments, the innovations can be used when some NFs disclose their actions while some do not, or even where NFs only disclose some of their actions. In such a case, the proposed mechanism may improve the performance of the analytics compared to a case where only the actions which are disclosed are taken into account by the NWDAF. Indeed, in the proposed mechanism, the effect of the non-disclosed actions could be implicitly captured by the learnt tagged behavior.

In additional or alternative embodiments, it can be easier to learn the behavior of the control policy of a NF in terms of its overall effect on the network state rather than to try to learn the impact of specific actions. Indeed, learning the impact of actions would require disentangling the effect of multiple actions taken almost simultaneously and with a potentially delayed impact.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a graph illustrating an example of monitored KPI of a network in accordance with some embodiments;

FIG. 3 are graphs illustrating examples of variations in monitored KPI o a network in response to different control policies being implemented in accordance with some embodiments;

FIGS. 4-5 are block diagrams illustrating examples of a system for performing closed-loop predictions in accordance with some embodiments;

FIG. 6 is a block diagram illustrating an example of a machine learning, ML, model for modeling the behavior of the network in accordance with some embodiments;

FIG. 7 is a signal flow diagram illustrating an example of signals communicated for performing closed-loop predictions in accordance with some embodiments;

FIG. 8 is a flow chart illustrating an example of operations performed by a system for closed-loop predictions in accordance with some embodiments;

FIG. 9 is a signal flow diagram illustrating an example of signals communicated for performing closed-loop predictions in accordance with some embodiments;

FIG. 10 is a flow chart illustrating an example of operations performed by a NWDAF in accordance with some embodiments;

FIG. 11 is a flow chart illustrating an example of operations performed by a NF in accordance with some embodiments;

FIG. 12 is a block diagram of a communication system in accordance with some embodiments;

FIG. 13 is a block diagram of a user equipment in accordance with some embodiments;

FIG. 14 is a block diagram of a network node in accordance with some embodiments;

FIG. 15 is a block diagram of a host, which may be an embodiment of the host of FIG. 12, in accordance with some embodiments;

FIG. 16 is a block diagram of a virtualization environment in accordance with some embodiments; and

FIG. 17 shows a communication diagram of a host communicating via a network node with a user equipment over a partially wireless connection in accordance with some embodiments.

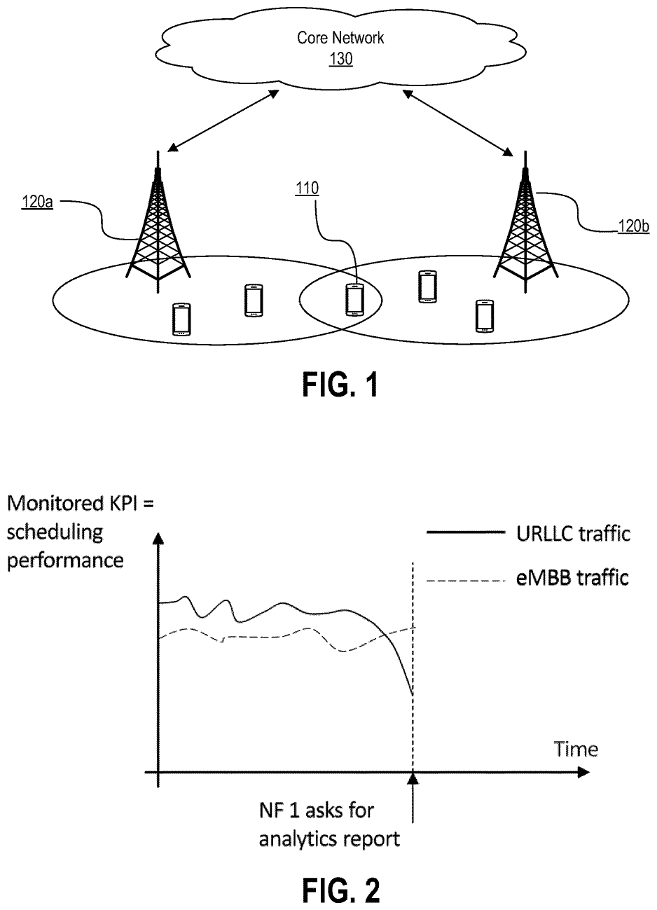

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

A network node can be configured to provide a network function (“NF”) and/or a network data analytics function (“NWDAF”). NFs can subscribe to a NWDAF to receive analytics reports, or NFs can transmit individual requests to the NWDAF for an analytic report. The analytics reports can include estimates of the current state of the network (e.g., estimates of some metrics, such as key performance indicators (“KPIs”), that are of interest to the NF) and predictions of the future state. In general, there are two types of predictions: 1) Open-loop predictions, which do not take into account the control actions which the NFs may take; and 2) Closed-loop predictions, which assume corrective actions will be taken by the NFs to maintain the network into a desirable state.

The open-loop predictions can allow the NFs to identify the need for a control action, but they can be uninformative of the expected impact of these actions, which can make it difficult for the NFs to select the best control action in every context. On the other hand, closed-loop predictions help assess if the assumed corrective actions by the NF are appropriate, which can lead to a more efficient network control by the NFs.

There currently exist certain challenges. Existing solutions for enabling closed-loop predictions at a network data analytics function (“NWDAF”) may require the NWDAF to use some information about the control actions exerted by the network functions (“NFs”). In some examples, such information may include an identifier (“ID”) of the action taken by the NF at a given time. Based on this information, the NWDAF can learn to predict the effect of the exerted control actions on the network state, and thus make a prediction on the future network state conditioned on a given control action being taken. However, this solution may not be feasible when no information about the control actions is available/used at the NWDAF.

Furthermore, for a closed-loop prediction by the NWDAF to be useful to the NF, the NF may need to understand which control actions were assumed by the NWDAF. Otherwise, the NF would know to which actions a prediction is concerned.

Various embodiments herein enable closed-loop predictions without the NWDAF using information about the control actions that the NFs perform. In some examples, the NWDAF may not use the information about the control actions because the NFs may want to keep their actions private (e.g., in case of multi-vendor operation where the NFs may not fully trust the NWDAF). In additional or alternative examples, the NWDAF may not use the information about the control actions because it may be too complicated to make efficient use of the knowledge of the exerted control actions (e.g., when many control actions are performed in a short duration).

In some examples, the control policy of an NF is the mapping between the past evolution of the (relevant) network state (e.g., the inputs to the NF) and the control actions it takes in the present & near future.

In additional or alternative examples, the behavior of a control policy of an NF is the mapping between the past evolution of the (relevant) network state and its future evolution, assuming that a specific control policy is used.

A NF may have different control policies but it may only use one of them at a time.

In some embodiments, the NWDAF learns the behavior of a specific control policy of the NF. For this, the NWDAF can observe the evolution of the network state while the NF only uses that specific control policy. Then, the NWDAF and NF can share an ID of the control policy (which can be a unique name for it). Of note, the NWDAF may not need any knowledge of the control actions, because it focused on the behavior of the control policy.

In additional or alternative embodiments, the NF requests a prediction associated with a control policy ID (which has been previously learnt). The NWDAF can use the learnt behavior associated with that specific ID to predict the future network state and can send that prediction to the NF. The NF can leverage the control policy associated with that specific ID to interpret the received prediction. For example, it may recover the actions which the control policy would have taken and interpret the prediction as being conditioned on these specific actions, thus enabling a useful closed-loop prediction.

The innovations herein can be referred to as focusing on the control policy of the NF rather than on specific control actions performed by the NF. In some examples, this requires different operations for the NWDAF to learn control policy behavior and different operations for the NF to use the predictions. The differences can include different communication between the NWDAF and the NF.

In some embodiments, during the learning phase, the NWDAF and the NF agree on a unique ID to refer to a specific control policy. During the learning phase, the NF can use the control policy. At the end of the learning phase, the NWDAF can store the learnt behavior and associate it to the control policy ID. At the end of the learning phase, the NF can store its control policy and associates it to the control policy ID.

In additional or alternative embodiments, during the prediction phase, the NF can send a prediction request along with a control policy ID. The NWDAF can use the learnt behavior associated with the requested control policy ID along with the past evolution of the network state to predict the future evolution of the network state under the associated control policy. Upon reception of the prediction, the NF can leverage the control policy associated with the requested ID to interpret the prediction and then decide to take actions or not.

FIG. 2 illustrates an example of a pair of KPIs monitored over time for an NF that implements a Cloud-RAN scheduler for a given network cell. The NF can monitor KPIs related to scheduling performance, such as the ratios of allocated to requested throughput for different types of flows (e.g., enhanced mobile broadband (“eMBB”) and ultra-reliable low latency communications (“URLLC”)). Based on the evolution of these KPIs, the NF might allocate more resources to the URLLC traffic to prevent performance degradation.

At this point, the NF may act in different manners to prevent URLLC performance to drop further. In some examples, the NF can implement a control policy in which it does nothing. The NF may do nothing if it assumes the drop in performance is only a random artifact and will be resolved naturally. In additional or alternative examples, the NF may immediately allocate 20% more resources (Physical Resource Blocks) to URLLC traffic, which may severely degrade eMBB performance, but may be performed because URLLC is a priority. In additional or alternative examples, the NF may gradually allocate more PRBs to URLLC traffic, in an attempt to strike a balance between the two types of traffic and avoid abruptly reducing eMBB resources.

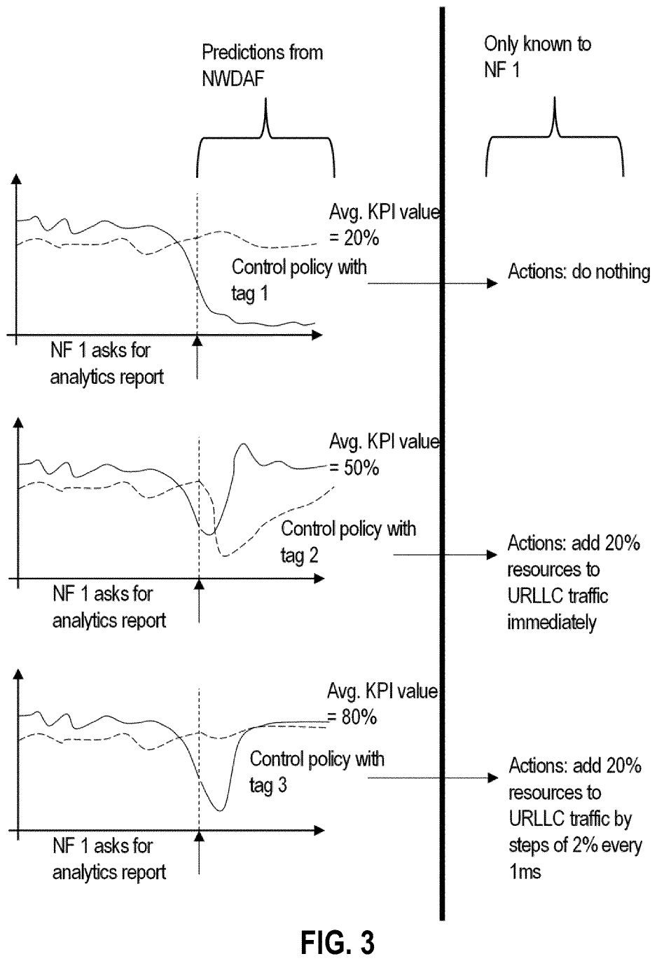

Assuming that the behaviors of these policies have been learnt in the past, the NWDAF will be able to predict the effect of the policies. The predictions from the NWDAF may be illustrated in FIG. 3.

As illustrated in FIG. 3, the actual actions corresponding to each policy are not known to the NWDAF but only to the NF. Given the predictions by the NWDAF, the NF can evaluate the benefits of each policy. For example, the NF may look at the average KPIs value for each policy and decide that policy π₃ was better. It can then decide to directly use control policy π₃. As another example, the NF may decide that it would want to obtain a KPI evolution in-between those of policies π₂ and π₃. It may then recover the actions of π₂ and π₃ and interpolate between them, which would be a new policy.

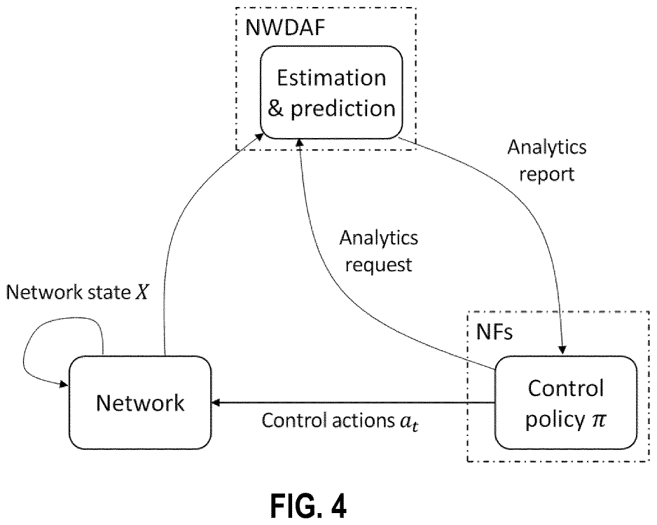

FIG. 4 illustrates a high-level system model for performing predictions. The analytics reports sent by the NWDAF to the NFs may typically include estimates \hat{X}ₜ of the current network state (i.e., relevant KPIs for the considered NF), open-loop predictions \hat{X}_{t+Δt} and closed-loop predictions \hat{X}^{π}_{t+Δt} assuming the behavior of some control policy π.

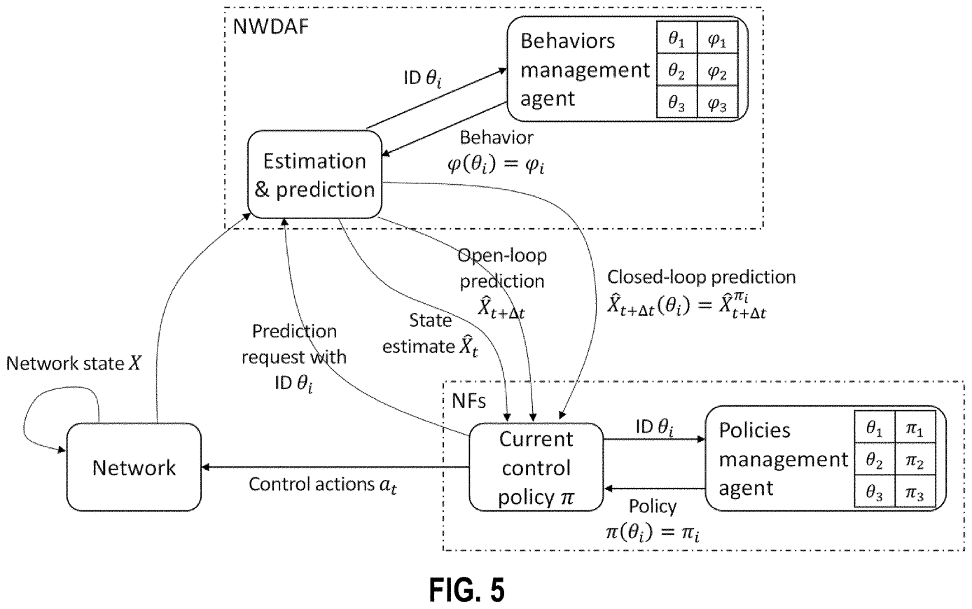

Machine learning (“ML”) models can be used in order to make closed-loop predictions assuming a specific control policy πᵢ is used by the NF. The ML used to predict the behavior of policy πᵢ can be referred to as φᵢ. The control policy πᵢ may not be known to the NWDAF, yet it can be referred to with an ID θᵢ shared with the NF. The NWDAF associates the ML model φᵢ with the ID θᵢ. Thus, the NWDAF can store multiple ML models associated with the IDs of the policies that have already been learnt. This functionality can be denoted as behavior management within the NWDAF in FIG. 5. Similarly, the NF can store multiple control policies associated with the IDs. The NF may be currently using one of these policies to decide its actions, or it may use a different policy.

When the NF wants to get a prediction assuming a given control policy is used. It can sends a prediction request with that ID. The NWDAF can ask its behavior management agent to provide the associated ML model representing the behavior of the policy and use this ML model to predict the future state of the network (using the past evolution of the network state as well). This prediction is then sent to the NF, possibly along with other analytics it may have requested, and which are part of typical analytics reports. Upon reception of the prediction, the NF asks its policy management agent to get the associated control policy, which is required to interpret the prediction. For example, as already mentioned, it might leverage the control policy to recover the actions it would have performed and interpret the prediction as feedback on the effect of these actions.

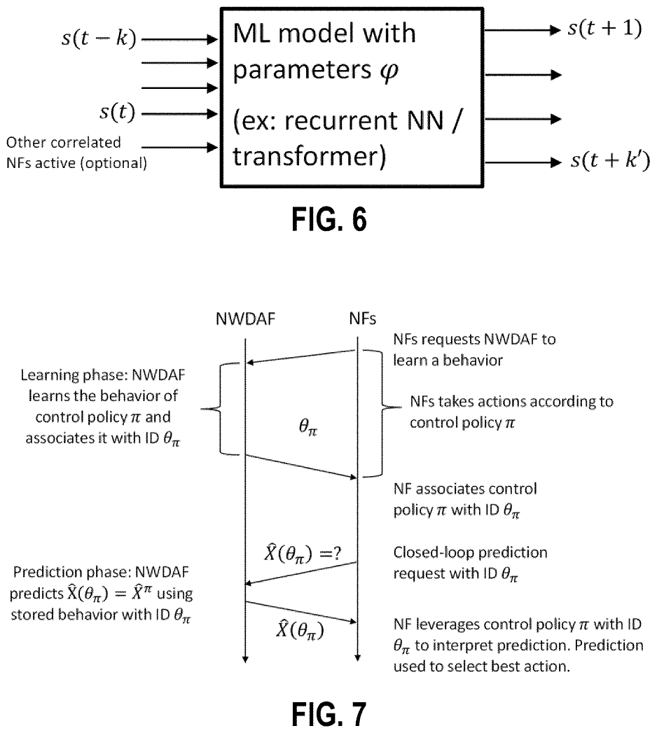

FIG. 6 illustrates an example of a ML model φᵢ. In order to predict the behavior of a control policy of the NF, the NWDAF trains a ML model φᵢ based on data collected in the learning phase, during which the NF only used control policy πᵢ. The inputs of such an ML model may be the past & current estimates of the network state, and the outputs are the future states.

This problem can be viewed as a sequence modeling problem, for which recurrent neural networks (“RNN”) such as transformers can be used or any other suitable architecture (e.g., ML models relying on Koopman operator theory).

In the NWDAF, the logical functions in charge of learning new ML models and performing predictions are the Model Training logical function (“MTLF”) and Analytics logical function (“AnLF”), respectively. The learning of the behavior of a control policy may be realized in the MTLF with extended capabilities to learn the type of ML models adapted to closed-loop predictions, or in a different function, which we may call policy behavior—Tha MTLF (“PB-MTLF”). The PB-MTLF can interact with the behavior management agent to store the learnt ML model predicting the behavior of a control policy it has learnt. When the AnLF has to provide a closed-loop prediction with a given policy ID, it retrieves the ML model predicting the behavior of that policy ID, either from the PB-MTLF or directly from the behavior management agent.

FIG. 7 illustrates an example of the messages exchanged between an NF and the NWDAF in order to set-up and the use the proposed mechanism. The messages relative to the learning phase are new compared to the state-of-the-art. Indeed, these messages may be required because the NWDAF may not be informed of the actions taken by the NFs and thus the NWDAF cannot learn on the fly while the NF would be taking arbitrary actions. During the learning phase, the NF may be forced to use the specific control policy to be learnt, thus this phase has to be delimited with dedicated messages. The prediction request by the NF may include new information, for example, the ID of the previously learnt policy.

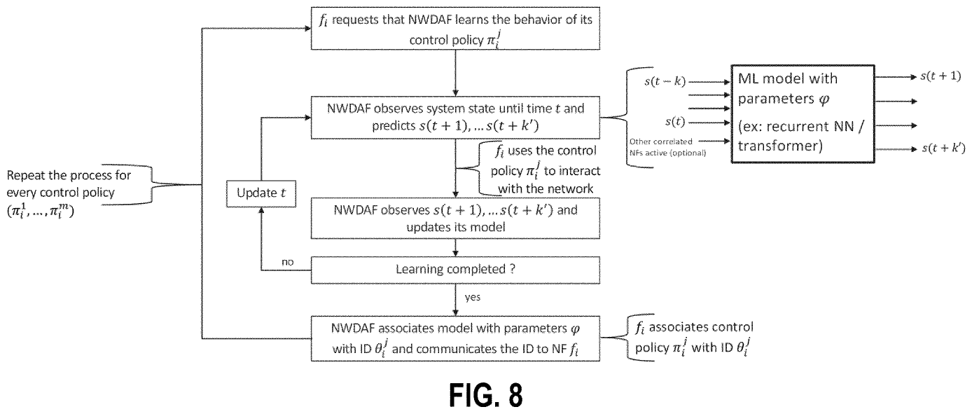

FIG. 8 illustrates an example of operations performed during the learning phase. As illustrated, the learning phases are distinct for the different policies which are learnt, because during each phase the NF uses a single policy. No information can be transferred from the behavior of one policy to that of another one (as opposed to if actions were observed by the NWDAF), which makes the scheme privacy-preserving regarding the NF policies.

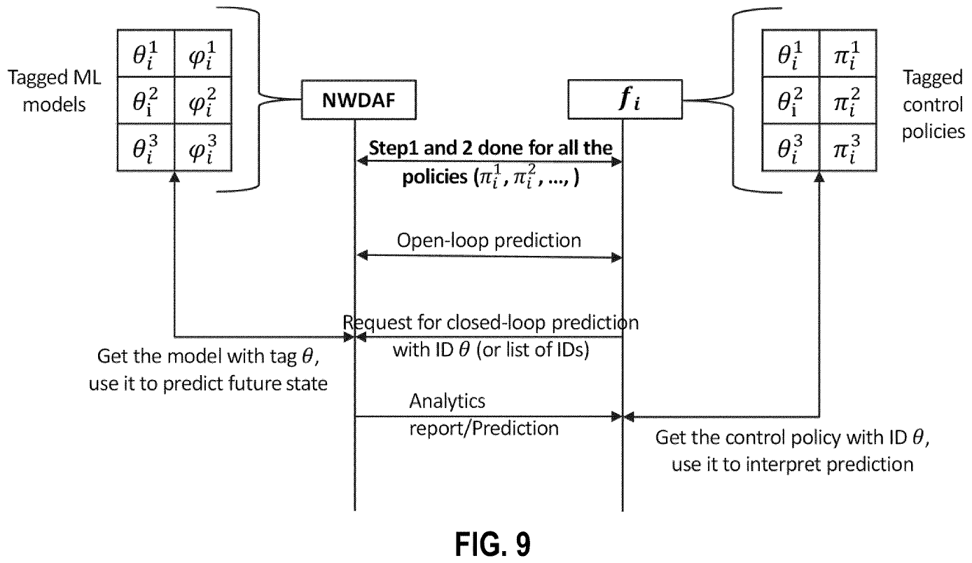

FIG. 9 illustrates an example of a temporal diagram of the prediction phase. As illustrated, the new mechanism for closed-loop predictions is not exclusive of other types of analytics reports.

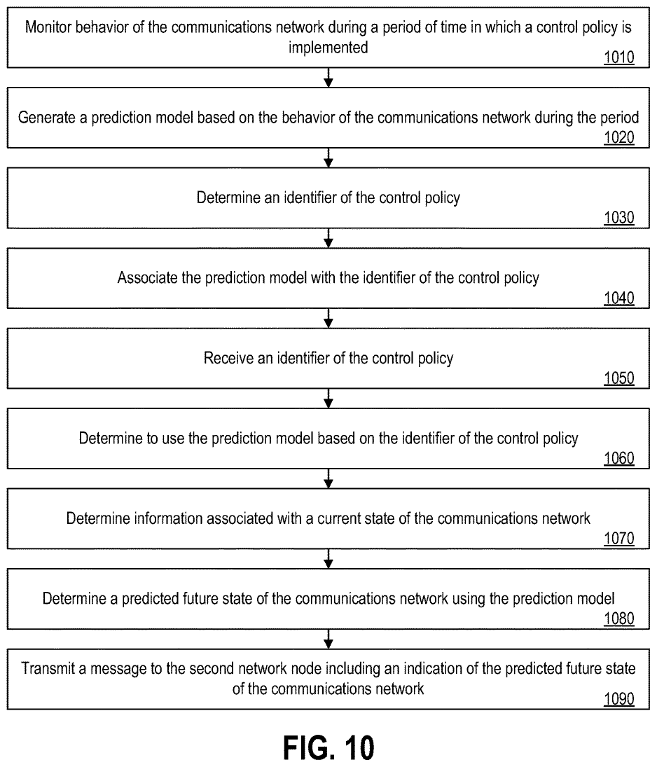

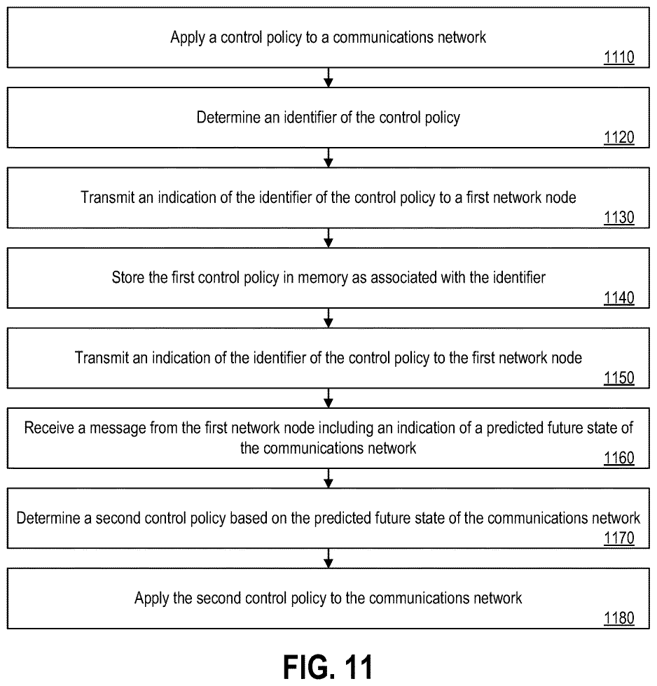

Operations of the RAN node 1400 (implemented using the structure of FIG. 14) will now be discussed with reference to the flow chart of FIGS. 10-11 according to some embodiments of inventive concepts. For example, modules may be stored in memory 1404 of FIG. 14, and these modules may provide instructions so that when the instructions of a module are executed by respective RAN node processing circuitry 1320, RAN node 1400 performs respective operations of the flow charts.

FIG. 10 illustrates an example of operations performed by a first network node (e.g., configured to perform a NWDAF)in a communications network that includes a second network node. In some embodiments, the first network node includes at least one of the second network node; a RAN node; and a base station.

At block 1010, processing circuitry 1402 monitors behavior of the communications network during a period of time in which a control policy implemented.

At block 1020, processing circuitry 1402 generates a prediction model based on the behavior of the communications network during the period of time.

At block 1030, processing circuitry 1402 determines an identifier of the control policy. In some embodiments, determining the identifier of the control policy includes receiving an indication of the identifier of the control policy from the second network node without an indication of control actions associated with the control policy. In additional or alternative embodiments, determining the identifier of the control policy includes: generating the identifier; and transmitting an indication of the identifier to the second network node and an indication that the identifier is associated with the control policy used during the time period.

At block 1040, processing circuitry 1402 associates the prediction model with the identifier of the control policy.

At block 1050, processing circuitry 1402 receives, via communication interface 1406, an identifier of the control policy.

At block 1060, processing circuitry 1402 determines to use the prediction model based on the identifier of the control policy. In some embodiments, associating the prediction model with the identifier includes storing the prediction model in memory as being associated with the identifier. Determining the prediction model includes retrieving the prediction model from the memory using the identifier.

At block 1070, processing circuitry 1402 determines information associated with a current state of the communications network.

At block 1080, processing circuitry 1402 determines a predicted future state of the communications network using the prediction model. In some embodiments, receiving the identifier of the control policy further includes receiving a request that the first network node provide the predicted future state of the communications network. Determining the predicted future state of the communications network using the prediction model includes determining the predicted future state of the communications network without using knowledge of control actions that are associated with the control policy. In some examples, the predicted future state is associated with an assumption that the control policy will be implemented by the second network node.

At block 1090, processing circuitry 1402 transmits, via communication interface 1406, a message to the second network node including an indication of the predicted future state of the communications network.

In some embodiments, the first network node is configured to provide a network data analytics function (“NWDAF”), the second network node is configured to provide a network function (“NF”), and the prediction model includes a machine learning (“ML”) model.

FIG. 11 illustrates an example of operations performed by a second network node (e.g., configured to perform a NF)in a communications network that includes a first network node. In some embodiments, the second network node includes at least one of the first network node; a RAN node; and a base station.

At block 1110, processing circuitry 1402 applies a control policy to a communications network.

At block 1120, processing circuitry 1402 determines an identifier of the control policy. In some embodiments, determining the identifier of the control policy includes transmitting an indication of the identifier of the control policy to the first network node without an indication of control actions associated with the control policy.

At block 1130, processing circuitry 1402 transmits, via communication interface 1406, an indication of the identifier of the control policy to a first network node. In some embodiments, transmitting the indication of the identifier of the first control policy includes transmitting the indication of the identifier of the first control policy to the first network node without providing the first network node with an indication of control actions associated with the first control policy.

Ab lock 1140, processing circuitry 1402 stores, via memory 1404, the first control policy in memory as associated with the identifier.

At block 1150, processing circuitry 1402 transmits, via communication interface 1406, an indication of the identifier of the control policy to the first network node. In some embodiments, transmitting the indication of the identifier of the first control policy further includes transmitting a request that the first network node provide a predicted future state of the communications network to the second network node. The predicted future state can be associated with an assumption that the first control policy will be implemented by the second network node.

At block 1160, processing circuitry 1402 receives, via communication interface 1406, a message from the first network node including an indication of a predicted future state of the communications network.

At block 1170, processing circuitry 1402 determines a second control policy based on the predicted future state of the communications network. In some embodiments, determining the second control policy includes: determining control actions associated with the identifier of the first control policy; evaluating an effectiveness of the control actions based on the predicted future state of the communications network; and selecting the second control policy based on the effectiveness of the control actions.

In additional or alternative embodiments, determining the second control policy includes retrieving the first control policy from the memory using the identifier.

At block 1180, processing circuitry 1402 applies the second control policy to the communications network.

Various operations from the flow chart of FIGS. 10-11 may be optional with respect to some embodiments of network nodes configured to provide NWDAF and/or NF and related methods.

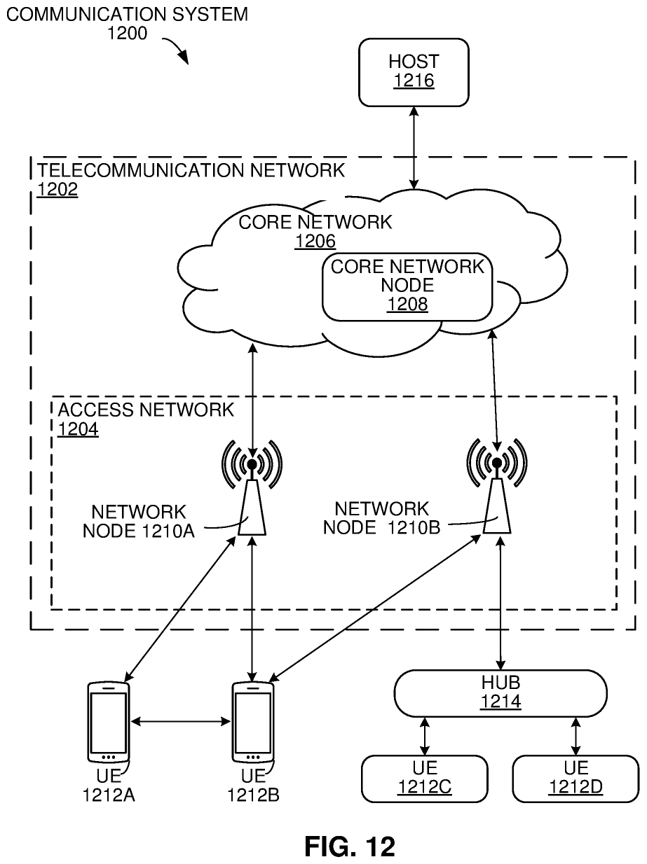

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. Moreover, as will be appreciated by those of skill in the art, the network nodes 1210 are not necessarily limited to an implementation in which a radio portion and a baseband portion are supplied and integrated by a single vendor. Thus, it will be understood that the network nodes 1210 may include disaggregated implementations or portions thereof. For example, in some embodiments, the telecommunication network 1202 includes one or more Open-RAN (ORAN) network nodes. An ORAN network node is a node in the telecommunication network 1202 that supports an ORAN specification (e.g., a specification published by the O-RAN Alliance, or any similar organization) and may operate alone or together with other nodes to implement one or more functionalities of any node in the telecommunication network 1202, including one or more network nodes 1210 and/or core network nodes 1208.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1210 facilitate direct or indirect connection of user equipment (UE), such as by connecting wireless devices 1212a, 1212b, 1212c, and 1212d (one or more of which may be generally referred to as UEs 1212) to the core network 1206 over one or more wireless connections. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

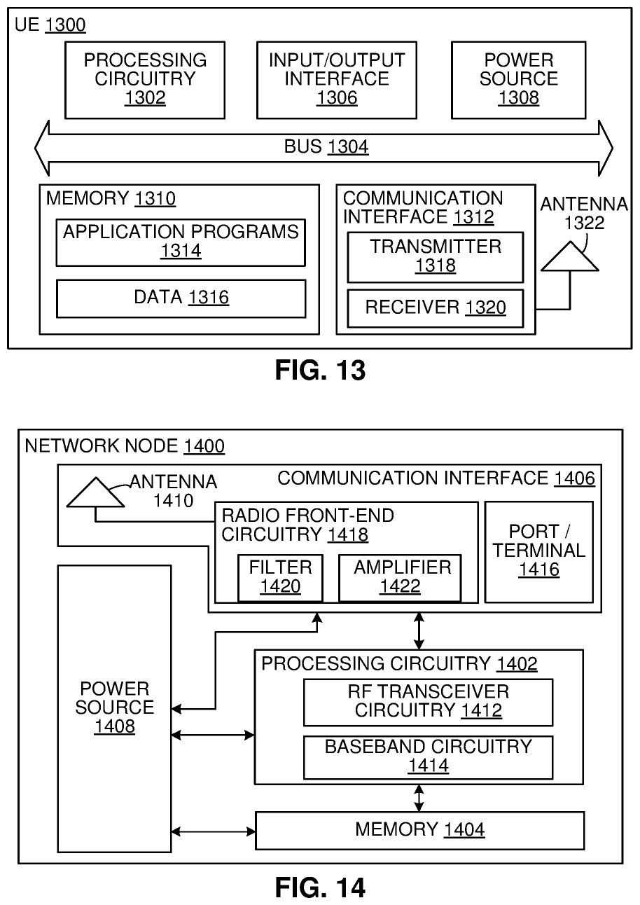

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

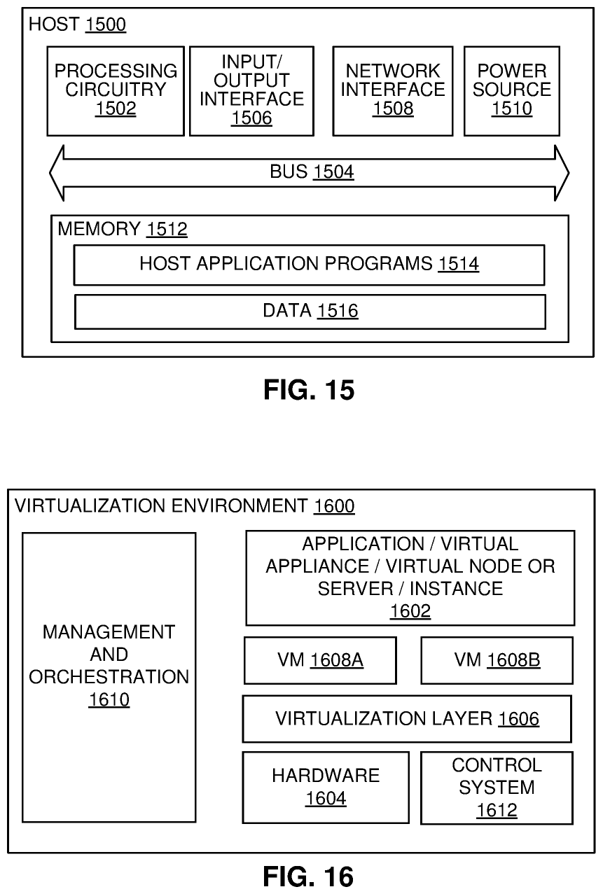

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1600 includes components defined by the O-RAN Alliance, such as an O-Cloud environment orchestrated by a Service Management and Orchestration Framework via an O-2 interface.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

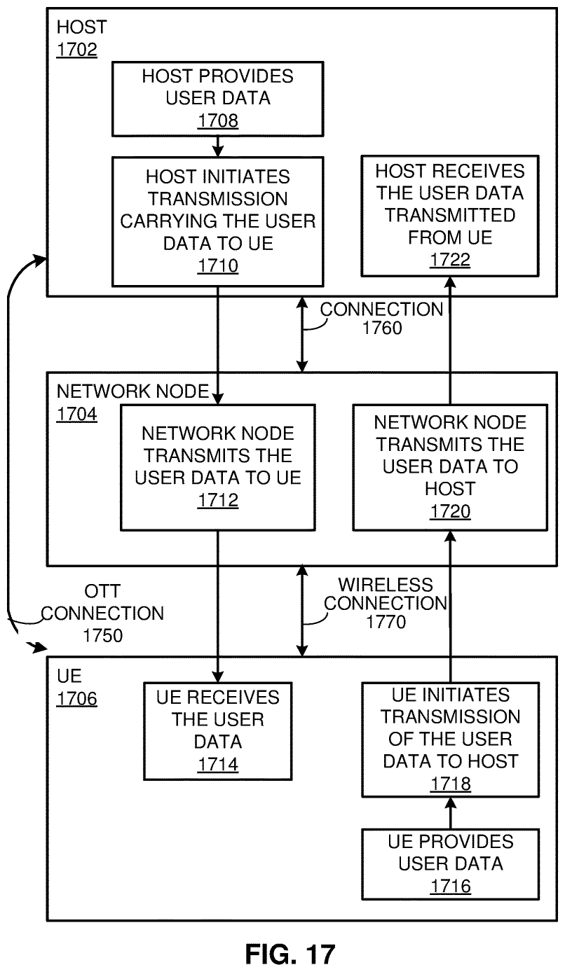

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may enable a NWDAF to perform closed-loop predictions without knowledge and/or use of information indicating specific control actions to be used by a NF.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc. ; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a first network node in a communications network that includes a second network node, the method comprising:
receiving an identifier of a control policy from the second network node;
determining a prediction model to use based on the identifier of the control policy;
determining a predicted future state of the communications network using the prediction model; and
transmitting a message to the second network node, the message including an indication of the predicted future state of the communications network.

2. A method performed by a first network node in a communications network that includes a second network node, the method comprising:
monitoring behavior of the communications network during a period of time in which a control policy is implemented by the second network node;
generating a prediction model based on the behavior of the communications network during the period of time;
determining an identifier of the control policy; and
associating the prediction model with the identifier of the control policy.

3. The method of claim 2, wherein the method performed by a first network node in a communications network that includes a second network node, further comprises:
receiving an identifier of a control policy from the second network node;
determining a prediction model to use based on the identifier of the control policy;
determining a predicted future state of the communications network using the prediction model; and
transmitting a message to the second network node, the message including an indication of the predicted future state of the communications network.

4. The method of claim 2, wherein determining the identifier of the control policy comprises receiving an indication of the identifier of the control policy from the second network node without an indication of control actions associated with the control policy.

5. The method of claim 2, wherein determining the identifier of the control policy comprises:
generating the identifier; and
transmitting an indication of the identifier to the second network node and an indication that the identifier is associated with the control policy used during the time period.

6. The method of claim 2, wherein associating the prediction model with the identifier comprises storing the prediction model in memory as being associated with the identifier, and
wherein determining the prediction model comprises retrieving the prediction model from the memory using the identifier.

7. The method of claim 3, wherein receiving the identifier of the control policy further comprises receiving a request that the first network node provide the predicted future state of the communications network, and
wherein determining the predicted future state of the communications network using the prediction model comprises determining the predicted future state of the communications network without using knowledge of control actions that are associated with the control policy, the predicted future state being associated with an assumption that the control policy will be implemented by the second network node.

8. The method of claim 1, further comprising:
determining information associated with a current state of the communications network,
wherein determining the predicted future state of the communications network comprises using the prediction model and the information.

9. The method of claim 1, wherein the first network node is configured to provide a network data analytics function, NWDAF,
wherein the second network node is configured to provide a network function, NF, and
wherein the prediction model comprises a machine learning, ML, model.

10. The method of claim 1, wherein the first network node comprises at least one of:
the second network node;
a radio access network, RAN, node; and
a base station.

11. A method performed by a second network node in a communications network that includes a first network node, the method comprising:
transmitting an indication of an identifier of a first control policy of a plurality of control policies to a first network node;
responsive to transmitting the identifier of the first control policy, receiving a message from the first network node, the message including an indication of a predicted future state of the communications network; and
determining a second control policy of the plurality of control policies based on the predicted future state of the communications network.

12. The method of claim 11, wherein transmitting the indication of the identifier of the first control policy comprises transmitting the indication of the identifier of the first control policy to the first network node without providing the first network node with an indication of control actions associated with the first control policy, and
wherein transmitting the indication of the identifier of the first control policy further comprises transmitting a request that the first network node provide a predicted future state of the communications network to the second network node, the predicted future state being associated with an assumption that the first control policy will be implemented by the second network node.

13. The method of claim 11, wherein determining the second control policy comprises:
determining control actions associated with the identifier of the first control policy;
evaluating an effectiveness of the control actions based on the predicted future state of the communications network; and
selecting the second control policy based on the effectiveness of the control actions.

14-18. (canceled)

19. The method of claim 11, further comprising:
storing the first control policy in memory as being associated with the identifier; and
wherein determining the second control policy comprises retrieving the first control policy from the memory using the identifier.

20. The method of claim 11, further comprising:
applying the second control policy to the communications network, the second control policy being different than the first control policy.

21. The method of claim 11, wherein the first network node is configured to provide a network data analytics function, NWDAF, and wherein the second network node is configured to provide a network function, NF.

22. The method of claim 11, wherein the second network node comprises at least one of:
the first network node;
a radio access network, RAN, node; and
a base station.

23. A network node, the network node comprising:
processing circuitry; and
memory coupled to the processing circuitry and having instructions stored therein that are executable by the processing circuitry to cause the network node to perform the operations of claim 1.

24-26. (canceled)

27. A network node, the network node comprising:
processing circuitry; and
memory coupled to the processing circuitry and having instructions stored therein that are executable by the processing circuitry to cause the network node to perform the operations of claim 2.
